(19) United States
(12) Patent Application Publication
(10) Pub. No.: US 2012/0098461 A1
(43) Pub. Date: Apr. 26, 2012

(54) POWER SUPPLY DETECTING CIRCUIT

(75) Inventors: LING-YU XIE, Shenzhen City (CN); XING-PING XIE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/152,404

(22) Filed: Jun. 3, 2011

(30) Foreign Application Priority Data
Oct. 22, 2010 (CN) 201010516893.7

(51) Int. Cl. H05B 37/02

(52) U.S. Cl. 315/297

(57) ABSTRACT

A phase sequence detecting apparatus for a three-phase alternating current (AC) power includes a signal converting module and a phase sequence indicating module comprising plural indicating lights. The phase sequence detecting apparatus further includes a control module. The signal converting module is configured to receive three phase power signals output from the three-phase AC power, configured to convert the three phase power signals and send the converted signals to the control module. The control module controls power-on sequence of the indicating lights according to signals output from the signal converting module.

### BACKGROUND

1. Technical Field

The present disclosure relates to a power supply detecting circuit capable of detecting a phase sequence of a polyphase power source.

2. Description of Related Art

Three-phase power sources are common polyphase power sources used by grids worldwide to transfer power. Three-phase power is also used to power large motors and other large loads. A three-phase system is generally more economical because it uses less conductor material to transmit electric power than equivalent single-phase or two-phase systems at the same voltage. A typical three-phase power source includes three output terminals which reach their instantaneous peak values at different times. Taking one power rail as the reference, the other two power rails are delayed in time by one-third and two-thirds of one cycle of the electric current. The three-phase power source has the only phase sequence and the power rails of the three-phase power source should be correctly connects to power input terminals of the three-phase motors or the three-phase loads. However, the phase sequence of the three-phase power supply is sometimes unknown to users, which causes the motors or loads are connected to the power source incorrectly.

Therefore, what is needed, is a power supply detecting circuit capable of detecting a phase sequence of the polyphase power supply.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a power supply detecting circuit according to an embodiment.

FIG. 2 is a detailed circuit of the power supply detecting circuit of FIG. 1.

FIG. 3 illustrates waveforms of output powers rails of a three-phase power source.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

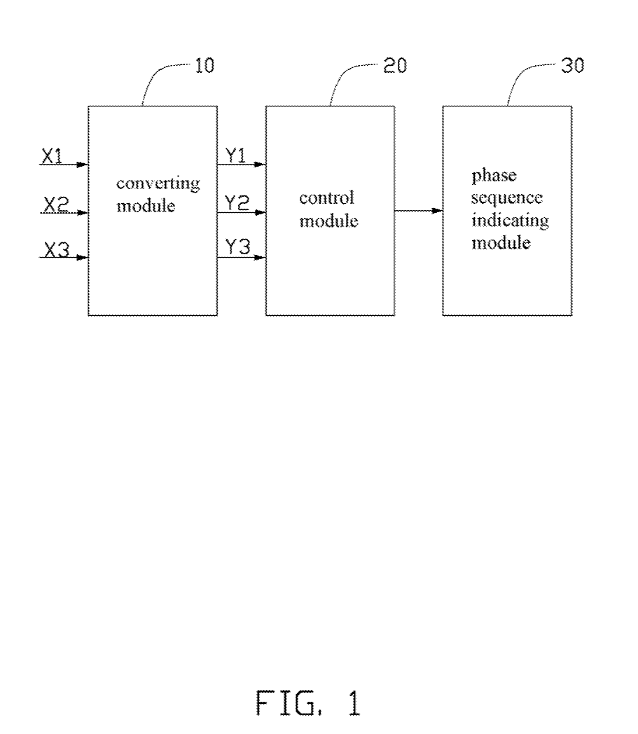

Referring to FIG. 1, an embodiment of power supply detecting circuit includes a converting module 10, a control module 20, and a phase sequence indicating module 30. In one embodiment, the power supply detecting circuit is configured to detect a phase order of a three-phase alternative current (AC) power source which has three live wires and a neutral wire. The three live wires output three AC power rails which reach their instantaneous peak values at different times. Taking one power rail as the reference, the other two power rails are delayed in time by one-third and two-thirds of one cycle of the electric current.

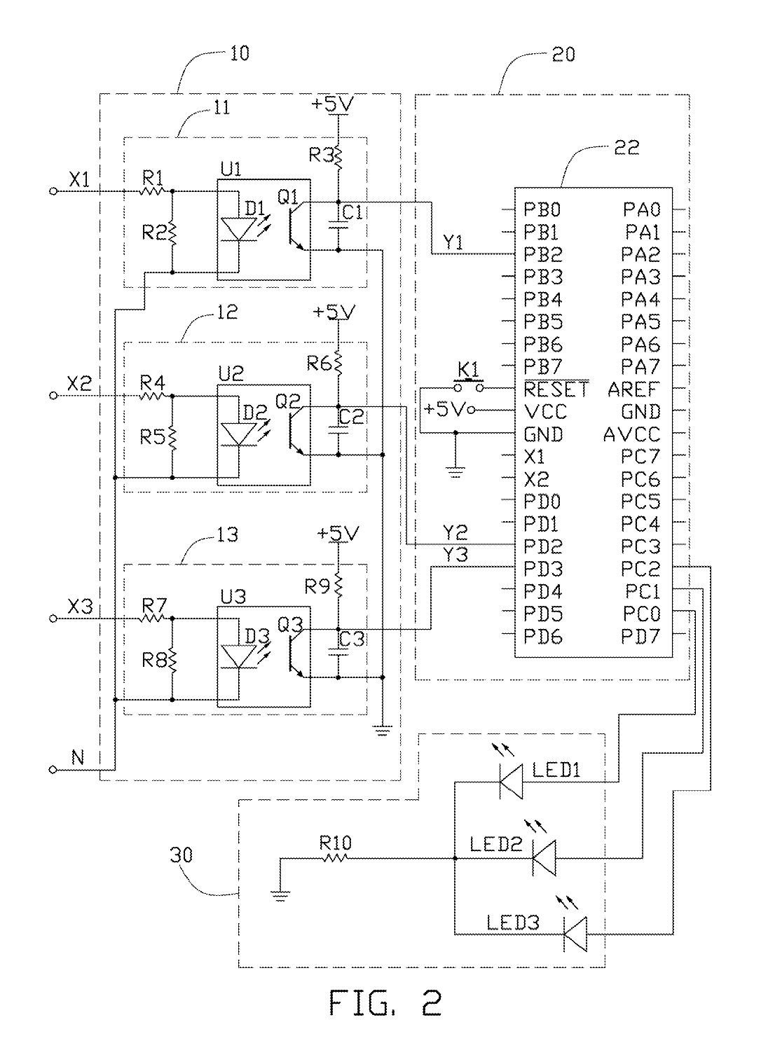

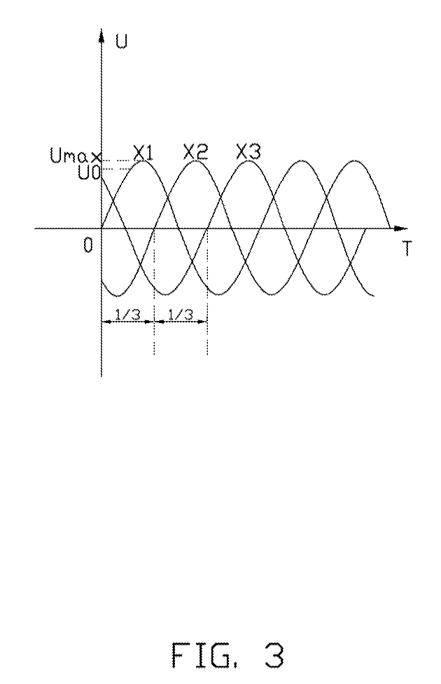

Referring to FIGS. 2 and 3, the converting module 10 includes a first signal converting circuit 11, a second signal converting circuit 12, and a third signal converting circuit 13.

The first signal converting circuit 11 includes a first resistor R1, a second resistor R2, a third resistor R3, a first optical coupler U1, and a first capacitor C1. A first terminal of the first resistor R1 is connected to a first live wire X1 of the three-phase AC power source. A second terminal of the first resistor R1 is connected to the first optical coupler U1. The first optical coupler U1 includes a first light emitting diode (LED) D1 and a first light sensitive transistor Q1. An anode of the first LED D1 is connected to the first resistor R1. A cathode of the first LED D1 is connected to the neutral wire N of the three-phase AC power source. The second resistor R2 and the first LED D1 are connected in parallel. A collector of the first light sensitive transistor Q1 is coupled to a +5V direct current (DC) power via the third transistor R3. An emitter of the first light sensitive transistor Q1 is connected to ground. The first capacitor C1 is connected between the collector and the emitter of the first light sensitive transistor Q1. When a voltage output from the first live wire X1 exceeds a predetermined threshold value U0 (see FIG. 3), the first LED D1 is lit. The first light sensitive transistor Q1 is rendered conductive. The first signal converting circuit 11 outputs a low level voltage Y1 (Y1=0V) to the control module 20. When the voltage output from the first live wire X1 is less than the predetermined threshold value U0, the first LED D1 is powered off. The first light sensitive transistor Q1 is rendered non-conductive. The first signal converting circuit 11 outputs a high level voltage Y1 (Y1=+4.8V) to the control module 20. In one embodiment, a resistance of the first resistor R1 is much greater than that of the second resistor R2. Thus, a voltage drop across the first resistor R1 is much greater than that across the second resistor R2, so that the first resistor R1 can prevent overvoltage damage to the first LED D1.

The second signal converting circuit 12 includes a fourth resistor R4, a fifth resistor R5, a sixth resistor R6, a second optical coupler U2, and a second capacitor C2. A first terminal of the fourth resistor R4 is connected to a second live wire X2 of the three-phase AC power source. A second terminal of the fourth resistor R4 is connected to the second optical coupler U2. The second optical coupler U2 includes a second LED D2 and a second light sensitive transistor Q2. An anode of the second LED D2 is connected to the fourth resistor R4. A cathode of the second LED D2 is connected to the neutral wire N of the three-phase AC power source. The fifth resistor R5 and the second LED D2 are connected in parallel. A collector of the second light sensitive transistor Q2 is coupled to the +5V DC power via the sixth transistor R6. An emitter of the second light sensitive transistor Q2 is connected to ground. When a voltage output from the second live wire X2 exceeds the predetermined threshold value U0 (see FIG. 3), the second LED D2 is lit. The second light sensitive transistor Q2 is rendered conductive. The second signal converting circuit 12 outputs a low level voltage Y2 (Y2=0V) to the control module 20. When the voltage output from the second live wire X2 is less than the predetermined threshold value U0, the second LED D2 is powered off. The second light sensitive transistor Q2 is rendered non-conductive. The second signal converting circuit 12 outputs a high level voltage Y2 (Y2=+4.8V) to the control module 20. A resistance of the fourth resistor R4 is much greater than that of the fifth resistor R5. Thus, the fourth resistor R4 can prevent overvoltage damage to the second LED D2.

The third signal converting circuit 13 includes a seventh resistor R7, an eighth resistor R8, a ninth resistor R9, a third optical coupler U3, and a third capacitor C3. A first terminal of the seventh resistor R7 is connected to a third live wire X3 of the three-phase AC power source. A second terminal of the seventh resistor R7 is connected to the third optical coupler U3. The third optical coupler U3 includes a third LED D3 and a third light sensitive transistor Q3. An anode of the third LED D3 is connected to the seventh resistor R7. A cathode of the third LED D3 is connected to the neutral wire N. The eighth resistor R8 and the third LED D3 are connected in parallel. A collector of the third light sensitive transistor Q3 is coupled to the +5V DC power via the ninth transistor R9. An emitter of the third light sensitive transistor Q3 is connected to ground. When a voltage output from the third live wire X3 exceeds the predetermined threshold value U0 (see FIG. 3), the third LED D3 is lit. The third light sensitive transistor Q3 is rendered conductive. The third signal converting circuit 13 outputs a low level voltage Y3 (Y3=0V) to the control module 20. When the voltage output from the third live wire X3 is less than the predetermined threshold value U0, the third LED D3 is powered off. The third light sensitive transistor Q3 is rendered non-conductive. The third signal converting circuit 13 outputs a high level voltage Y3 (Y3=+4.8V) to the control module 20. A resistance of the seventh resistor R7 is much greater than that of the eighth resistor R8. Thus, the seventh resistor R7 can prevent overvoltage damage to the second LED D2.

In one embodiment, the first signal converting circuit 11, the second signal converting circuit 12, and the third signal converting circuit 13 have the same components and circuit connections.

The control module 20 includes a single chip microcontroller 22 with pins PA0-PA7 (I/O pins) [symbol] PB0-PB7 (I/O pins) [symbol] PC0-PC7 (I/O pins) [symbol] PD0-PD7 (I/O pins) [symbol] RESET (reset pin) [symbol] VCC (power pin) [symbol] GND (ground pin). The PB2 pin is connected to the first signal converting circuit 11 for receiving the output signal Y1. The PD2 pin is connected to the second signal converting circuit 12 for receiving the output signal Y2. The PD3 pin is connected to the third signal converting circuit 13 for receiving the output signal Y3. A reset key K1 is connected to the RESET pin of the single chip microcontroller 22. The VCC pin is coupled to the +5V DC power. The GND pin is connected to ground.

The phase sequence indicating module 30 includes a first indicator LED1, a second indicator LED2, and a third indicator LED3. The indicators are different colored LED lamps. An anode of the first indicator LED1 is connected to the PC0 pin of the single chip microcontroller 22. A cathode of the first indicator LED1 is connected to ground via a tenth resistor R10. An anode of the second indicator LED2 is connected to the PC1 pin of the single chip microcontroller 22. A cathode of the second indicator LED2 is connected to ground via the tenth resistor R10. An anode of the third indicator LED3 is connected to the PC2 pin of the single chip microcontroller 22. A cathode of the third indicator LED3 is connected to ground via the tenth resistor R10.

To detect the phase sequence of the three-phase AC power source, the reset key K1 is pressed, and the single chip microcontroller 22 starts to work. Then, the three-phase AC power source is switched on, and the live wires X1, X2, and X3 start to output AC voltages. If the phase sequence of the three-phase AC power source is X1→X2→X3, the X1 power rail firstly reaches the predetermined value U0. The first optical coupler U1 is switched on. The output signal Y1 from the first signal converting circuit 11 is at low level and sent to the PB2 pin of the single chip microcontroller 22. The PC0 pin of the single chip microcontroller 22 outputs a high level voltage to the first indicator LED1. The first indicator LED1 is lit firstly, while the second indicator LED2 and the third indicator LED3 are still powered off. After one third cycle, the X2 power rail reaches the predetermined value U0. The second optical coupler U2 is switched on. The output signal Y2 from the second signal converting circuit 12 is at low level and sent to the PD2 pin of the single chip microcontroller 22. The PC1 pin of the single chip microcontroller 22 outputs a high level voltage to the second indicator LED2. The second indicator LED2 is lit after one third cycle while the first indicator LED1 is still lit. After two third cycles, the X3 power rail reaches the predetermined value U0. The third optical coupler U3 is switched on. The output signal Y3 from the third signal converting circuit 13 is at low level and sent to the PD3 pin of the single chip microcontroller 22. The PC2 pin of the single chip microcontroller 22 outputs a high level voltage to the third indicator LED3. The third indicator LED3 is lit after another one third cycle. Thus the first indicator LED1, the second indicator LED2, and the third indicator LED3 are lit one by one in sequence; LED1→LED2→LED3. Then the phase sequence of the three-phase AC power source is X1→X2→X3. If the first indicator LED1, the second indicator LED2, and the third indicator LED3 are lit one by one in a different sequence; L2→L3→L1, then the phase sequence of the three-phase AC power source is X2→X3→X1. If the first indicator L1, the second indicator L2, and the third indicator L3 are lit one by one in yet another sequence; LED3→LED2→LED1, the phase sequence of the three-phase AC power source is X3→X2→X1. The power on sequence of the first indicator LED1, the second indicator LED2, and the third indicators LED3 indicate the phase sequence of the three-phase AC power source being tested.

In one embodiment, the AC power source to be tested is a two phase, or four or more phase AC power source, and circuits similar to the above described detecting circuit can be utilized to detect the phase sequence of the polyphase AC power source.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A circuit for detecting a phase sequence of a polyphase power source that outputs polyphase alternative current (AC) voltages, the circuit comprising:
a converting module, having multiple signal receiving terminals for receiving the polyphase AC voltages, adapted to covert the polyphase AC voltages to transistor to transistor logic (TTL) signals;
a control module configured to receive the TTL signals and output driving signals according to the TTL signals; and
a phase sequence indicating module comprising a plurality of indicating lamps coupled to the driving signals;
wherein the driving signals are adapted to light up the plurality of indicating lamps one by one as a sequence according to the phase sequence of the polyphase power source.

2. The circuit of claim 1, wherein the converting module includes a first signal converting circuit, a second signal converting circuit, and a third signal converting circuit for receiving the polyphase AC voltages; and the first signal converting circuit, the second signal converting circuit, and the third signal converting circuit are connected in parallel.

3. The circuit of claim 2, wherein the first signal converting circuit includes a first switch component connected to the control module, the first switch component is adapted to be switched on, when one of the polyphase AC voltages received by the first signal converting circuit exceeds a predetermined value, and adapted to be switched off, when one of the polyphase AC voltages received by the first signal converting circuit is less than the predetermined value.

4. The circuit of claim 3, wherein the first switch component is an optical coupler, and the optical coupler comprises a light emitting diode (LED) and a light sensitive transistor connected to the control module.

5. The circuit of claim 4, wherein the first signal converting circuit further comprises a first resistor and a second resistor, a first terminal of the first resistor is coupled to one of the polyphase AC voltages, a second terminal of the first resistor is connected to an anode of the LED, a cathode of the LED is connect to a neutral wire of the polyphase power source, the second resistor and the LED are connected in parallel, a collector of the light sensitive transistor is coupled to a direct current power via a third resistor and connected to the control module, and an emitter of the light sensitive transistor is connected to ground.

6. The circuit of claim 5, wherein a resistance of the first resistor is greater than that of the second resistor.

7. The circuit of claim 2, wherein the second signal converting circuit includes a second switch component connected to the control module, the second switch component is adapted to be switched on, when one of the polyphase AC voltages received by the second signal converting circuit exceeds a predetermined value; and the third signal converting circuit comprises a third switch component connected to the control module, the third switch component is adapted to be switched on when one of the polyphase AC voltages received by the third signal converting circuit exceeds the predetermined value.

8. The circuit of claim 2, wherein the control module comprises a single chip microcontroller, the first signal converting circuit, the second signal converting circuit, and the third signal converting circuit are connected to different I/O ports of the single chip microcontroller.

9. The circuit of claim 8, wherein the plurality of indicating lamps are LEDS connected to different I/O ports of the single chip microcontroller to receive the driving signals.

10. A circuit comprising:
a polyphase power source have a plurality of live wires adapted to output polyphase voltages and a neutral wire;
a signal converting module, having multiple signal receiving terminals for receiving the polyphase voltages, adapted to covert the polyphase voltages to transistor to transistor logic (TTL) signals;
a control module adapted to receive the TTL signals and output driving signals according to the TTL signals; and
a phase sequence indicating module comprising a plurality of indicating lamps coupled to the driving signals;
wherein the driving signals are adapted to light up the plurality of indicating lamps one by one as a sequence according to the phase sequence of the polyphase power source.

11. The circuit of claim 10, wherein the signal converting module includes a first signal converting circuit, a second signal converting circuit, and a third signal converting circuit for receiving the polyphase voltages, and the first signal converting circuit, the second signal converting circuit, and the third signal converting circuit are connected in parallel.

12. The circuit of claim 11, wherein the first signal converting circuit includes a first switch component connected to the control module, the first switch component is adapted to be switched on, when one of the polyphase voltages received by the first signal converting circuit exceeds a predetermined value, and adapted to be switched off when one of the polyphase voltages received by the first signal converting circuit is less than the predetermined value.

13. The circuit of claim 12, wherein the first switch component is an optical coupler, and the optical coupler comprises a light emitting diode (LED) and a light sensitive transistor connected to the control module.

14. The circuit of claim 13, wherein the first signal converting circuit further comprises a first resistor and a second resistor, a first terminal of the first resistor is coupled to one of the polyphase AC voltages, a second terminal of the first resistor is connected to an anode of the LED, a cathode of the LED is connect to the neutral wire, the second resistor and the LED are connected in parallel, a collector of the light sensitive transistor is coupled to a direct current power via a third resistor and connected to the control module, and an emitter of the light sensitive transistor is connected to ground.

15. The circuit of claim 14, wherein a resistance of the first resistor is greater than that of the second resistor.

16. The circuit of claim 11, wherein the second signal converting circuit includes a second switch component connected to the control module, the second switch component is adapted to be switched on when one of the polyphase voltages received by the second signal converting circuit exceeds a predetermined value; and the third signal converting circuit comprises a third switch component connected to the control module, the third switch component is adapted to be switched on when one of the polyphase voltages received by the third signal converting circuit exceeds the predetermined value.

17. The circuit of claim 11, wherein the control module comprises a single chip microcontroller, the first signal converting circuit, the second signal converting circuit, and the third signal converting circuit are connected to different I/O ports of the single chip microcontroller.

18. The circuit of claim 17, wherein the plurality of indicating lamps are LEDS connected to different I/O ports of the single chip microcontroller to receive the driving signals.

19. The circuit of claim 10, wherein the polyphase power source is a three-phase power source.
